(19) United States
(12) Patent Application Publication
(10) Pub. No.: US 2026/0073119 A1
(43) Pub. Date: Mar. 12, 2026

(54) INFORMATION PROCESSING SYSTEM AND INFORMATION PROCESSING METHOD

(71) Applicant: CANON KABUSHIKI KAISHA, Tokyo (JP)

(72) Inventors: MASAYUKI ONO, Kanagawa (JP); YOSHIHARU SEKI, Tokyo (JP); RYUICHI KAMANO, Tokyo (JP)

(21) Appl. No.: 19/317,306

(22) Filed: Sep. 3, 2025

(30) Foreign Application Priority Data
Sep. 6, 2024 (JP) 2024-154142
Jul. 23, 2025 (JP) 2025-123088

(51) Int. Cl. G06F 40/111; G06F 3/0482

(52) U.S. Cl. CPC G06F 40/111; G06F 3/0482

(57) ABSTRACT

An information processing system comprising: an input portion configured to receive, as input to a main storage device that stores data including an attribute having a unit, input information comprising numeric data for the attribute; an arithmetic portion, configured to evaluate, based on the input information and unit information, whether the numeric data is appropriate when regarded as being expressed in each of the plurality of unit candidates, wherein the unit information includes information on a plurality of unit candidates that may be assigned to the attribute, information on a specified unit of the attribute that is selected from the plurality of unit candidates, and information on conversion from the plurality of unit candidates to the specified unit; and the display portion configured to display, on a display device, a unit candidate, which differs from the specified unit, from among the plurality of unit candidates that are evaluated as appropriate.

### BACKGROUND

### Field of the Technology

The present disclosure relates to an information processing system and an information processing method, and more particularly to an information processing system and an information processing method for supporting input of data including units.

### Description of the Related Art

In a conventional apparatus to which data including units is inputted, techniques to detect errors in numerical values and units and convert these errors into appropriate values and units have been known.

JP-A-2021-152736 discloses a calculation method and a program, which determine whether an inputted value is reasonable or not by comparing the value with a predetermined numerical range, and convert the value if it is determined that the value is unreasonable.

JP-A-2012-203482 discloses an information processing apparatus and a method of displaying a screen thereof, which prevent generation of input error by prompting a user to check whether there is an input error of the inputted information by using a different expression but having the same meaning.

### SUMMARY

It is an object of the present disclosure to provide a technique that enables more appropriate estimation and presentation to the user of the originally intended unit in a case where an inputted value is not reasonable.

The first aspect of the disclosure is an information processing system comprising:
an input portion configured to receive, as input to a main storage device that stores data including an attribute having a unit, input information comprising numeric data for the attribute;
an arithmetic portion, configured to evaluate, based on the input information and unit information, whether the numeric data included in the input information is appropriate when regarded as being expressed in each of the plurality of unit candidates, wherein the unit information includes information on a plurality of unit candidates that may be assigned to the attribute, information on a specified unit of the attribute that is selected from the plurality of unit candidates, and information on conversion from the plurality of unit candidates to the specified unit; and
the display portion configured to display, on a display device, a unit candidate, which differs from the specified unit, from among the plurality of unit candidates that are evaluated as appropriate.

The second aspect of the disclosure is an information processing method comprising:
an input step of receiving, as input to a main storage device that stores data including an attribute having a unit, input information comprising numeric data for the attribute;
an evaluation step of evaluating, based on the input information and unit information, whether the numeric data included in the input information is appropriate when regarded as being expressed in each of the plurality of unit candidates, wherein the unit information includes information on a plurality of unit candidates that may be assigned to the attribute, information on a specified unit of the attribute that is selected from the plurality of unit candidates, and information on conversion from the plurality of unit candidates to the specified unit; and
a display step of displaying, on a display device, a unit candidate, which differs from the specified unit, from among the plurality of unit candidates that are evaluated as appropriate.

The third aspect of the disclosure is a computer readable storage medium, non-transitorily storing a program causing a computer to execute:
an input step of receiving, as input to a main storage device that stores data including an attribute having a unit, input information comprising numeric data for the attribute;
an evaluation step of evaluating, based on the input information and unit information, whether the numeric data included in the input information is appropriate when regarded as being expressed in each of the plurality of unit candidates, wherein the unit information includes information on a plurality of unit candidates that may be assigned to the attribute, information on a specified unit of the attribute that is selected from the plurality of unit candidates, and information on conversion from the plurality of unit candidates to the specified unit; and
a display step of displaying, on a display device, a unit candidate, which differs from the specified unit, from among the plurality of unit candidates that are evaluated as appropriate.

Features of the present disclosure will become apparent from the following description of embodiments with reference to the attached drawings.

### BRIEF DESCRIPTION OF THE DRAWINGS

FIG. 1 is a schematic block diagram depicting a configuration of an information processing system according to an embodiment;

FIG. 2 is a diagram indicating a data configuration of a main database according to an embodiment;

FIG. 3 is a diagram indicating a data configuration of a unit database according to an embodiment;

FIG. 4 is a table indicating an input interface according to an embodiment;

FIG. 5 is a flow chart depicting an input support method according to an embodiment;

FIG. 6 is a diagram indicating an example of a method of converting each unit candidate into a standard unit;

FIG. 7 is a diagram indicating an example of a method of calculating a score of each unit candidate;

FIG. 8 is a graph indicating an example of a relationship between a value after being converted into a standard unit and a score;

FIG. 9 is a diagram indicating an example of a first display method of unit candidates;

FIG. 10 is a diagram indicating an example of a second display method of unit candidates;

FIG. 11 is a diagram indicating an example of a method of displaying a warning for an outlier value;

FIG. 12 is a diagram indicating a flow of processing after input determination;

FIG. 13 is a diagram indicating an example of a method of calculating a score of each unit candidate;

FIG. 14 is a diagram indicating an example of a method of calculating a score of each unit candidate; and

FIG. 15 is a diagram indicating an example of a method of calculating a score of each unit candidate.

### DESCRIPTION OF THE EMBODIMENTS

In a case of inputting data having units, units of physical quantity may be mistaken, and an unintended value may be inputted. For example, a value of length that should be inputted by an m (meter) unit may be inputted by an mm (millimeter) unit in error. If such an input error occurs, a value that is 1000 times the intended value is inputted, and problems occur when this data is used. This problem becomes more conspicuous in the case of a physical quantity having relatively complicated dimensional units, such as density, specific heat and thermal conductivity.

In the case of JP-A-2021-152736, if it is determined that an inputted value is inappropriate, converting means, that is set in advance, automatically converts the value so as to satisfy conditions in a numerical value range. However in the method of JP-A-2021-152736, conversion of numeric values and units is performed appropriately only for a unit corresponding to the conversion means that is set in advance, and a plurality of unit candidates cannot be considered. Further, in the method of JP-A-2021-152736, if a range of appropriate values is wide, it is likely that conversion into intended numeric values and units becomes difficult. For example, in the case of handling material physical property data, physical quantity, such as density and thermal conductivity, could become a value that is different by three digits or more. In such a case, even if a value that is 1000 times a correct value that should be inputted is inputted in error, the result cannot be determined as inappropriate, and cannot be converted into an appropriate numeric value and unit.

In the case of JP-A-2012-203482, the user is prompted to check whether there are any errors in the input information using a different expression having a same meaning in order to prevent the generation of input error. However, it is the user who converts the input error into an appropriate value. Therefore, in a case of handling a physical quantity having relatively complicated dimensional units, such as density and specific heat in JP-A-2012-203482, it is necessary to perform cumbersome conversion of numeric values and units.

### FIRST EMBODIMENT

A first embodiment of the present disclosure will be described with reference to the drawings. In the following description, an embodiment where the present disclosure is applied to an information processing system used for a database handling material physical property values will be described, but the present disclosure is not limited thereto.

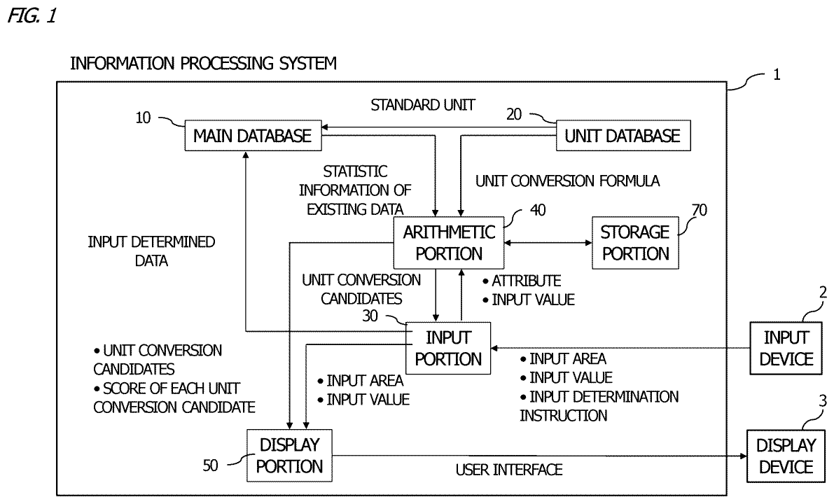

FIG. 1 is a schematic block diagram of an information processing system 1 used for a database handling material physical property values. The information processing system 1 includes a main database 10, a unit database 20, an input portion 30, an arithmetic portion 40, and a display portion 50. The main database 10 corresponds to a main storage device in this disclosure, and the unit database 20 corresponds to a unit storage device in this disclosure.

The input portion 30 has a function to receive input information which the user sent via an input device 2. The display portion 50 has a function to display information via a display device 3.

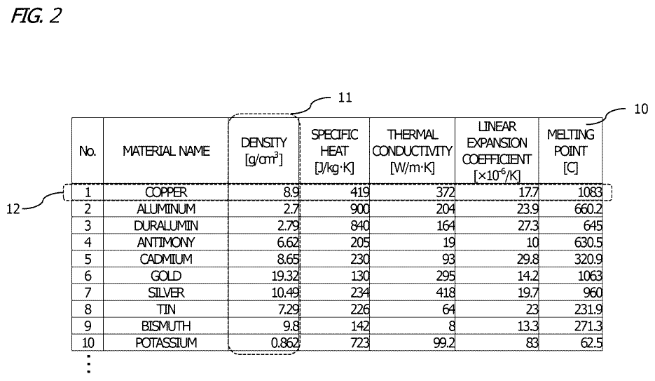

FIG. 2 is a diagram indicating data configuration of the main database 10. The main database 10 stores a plurality of records which include a plurality of attributes for which a pre-determination unit is set respectively. This data is stored in a matrix as a whole. An example of the attribute is indicated by a reference number 11, and an example of the record is indicated by a reference number 12. Here in this example, the attribute corresponds to a physical property value, and in each record, an internal ID (No.) and a material name are assigned. In this example, a unit is set in advance for each attribute, and the attribute value of each record is numeric value expressed in this unit. For example, density is set to be inputted in the unit [g/cm³], and the density data “8.9” of the record of “copper” indicates that the density is 8.9 g/cm³. Each record may include an attribute for which the unit is not set, such as category data, name data and label data.

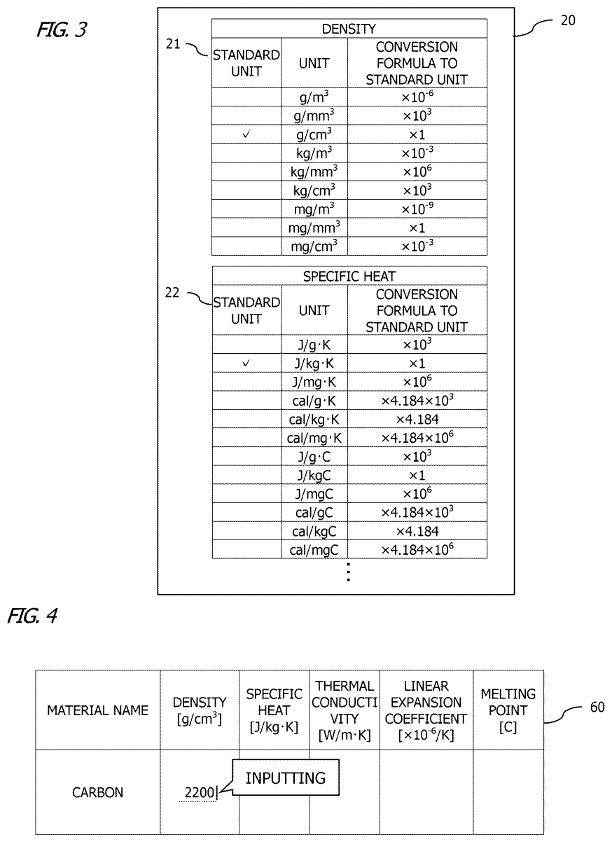

FIG. 3 is a diagram indicating a data configuration of the unit database 20. The unit database 20 is a database recording a plurality of unit candidates that can be assigned to each physical quantity (attribute), information that indicates a unit selected for the standard unit, and a conversion formula used to convert each unit candidate into the standard unit. “Standard unit” here is a representative unit that is set by each physical quantity, and is selected by the user out of unit candidates. “Unit candidates that can be assigned” can also mean “units that the user may input in error”. The plurality of unit candidates, the standard unit, and the conversion formula, used to convert each unit candidate into the standard unit, are defined for each attribute of the main database 10, and are stored in the unit database 20. In the present disclosure, information on the plurality of unit candidates, the standard unit and the conversion formula used to convert each unit candidate into the standard unit, which are stored in the unit database 20, are collectively called “unit information”.

In FIG. 3, unit data 21 related to the density and unit data 22 related to the specific heat are indicated as an example of the data configuration of the unit database 20. In this example, the density is set by the standard unit [g/cm³], and the user is expected to input data using [g/cm³]. However, the user may use [g/m³], [g/mm³] or the like in error, and these units are recorded as unit candidates. The physical quantity can be expressed in various units like this, and therefore in the unit database 20, the unit candidates that may be used, the unit that should actually be used (standard unit) and the conversion formula used to convert each unit candidate into the standard unit, are included. The standard unit may also be called “specified unit”, “unit in use”, “display unit” or the like.

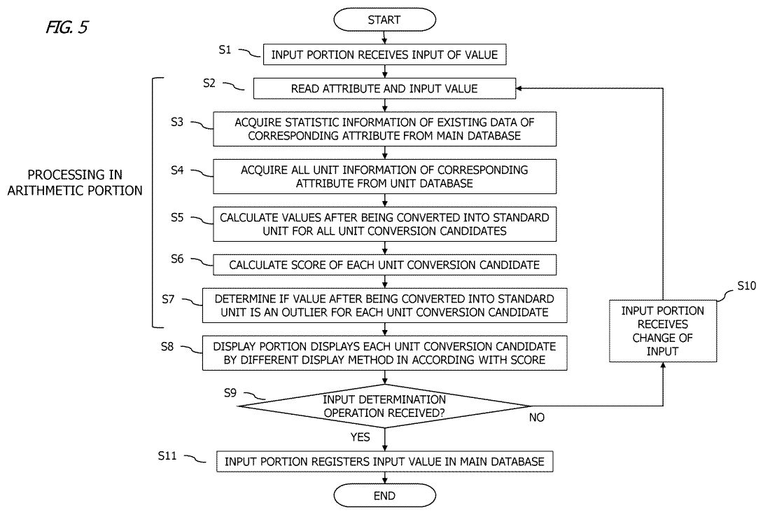

FIG. 4 indicates an input interface 60 provided by the input portion 30. The input portion 30 can receive input information, including numeric data (input to each attribute of the main database 10) via the input interface. As indicated in FIG. 4, the user can input a value for each attribute (physical property value) using the input interface 60. In FIG. 4, the input interface 60 is in a state where value “2200” is being inputted to the attribute “density”.

The arithmetic portion 40 evaluates, based on the unit information and the input information, whether or not the numeric data (input value) included in the input information is an appropriate value if the numeric data is expressed in each of the plurality of unit candidates. For example, the arithmetic portion 40 calculates a score to be an index of appropriateness for each of the plurality of unit candidates based on the unit information, the input value, and existing data, and evaluates the appropriateness based on this score. The score is an index indicating a statistic appropriateness when the input value is regarded as expressed in each unit candidate stored in the unit database 20, and is calculated using a value determined by converting the input value into the standard unit, and the existing data.

The display portion 50 displays the input interface 60, provided by the input portion 30, on the display device 3. When the user is inputting a value via the input interface 60, the display portion 50 displays on the input interface 60 unit candidates which are different from the standard unit, from among a plurality of unit candidates which the arithmetic portion 40 evaluated as appropriate, as units the user erroneously used. The unit candidates that are different from the standard unit may be displayed only when the input value is evaluated as inappropriate if it were expressed in a standard unit, or may be displayed in other cases as well. The display portion 50 displays the unit candidates by a different method in accordance with the score.

The information processing system 1 is constituted of one or a plurality of computers, including a processor and a memory, and provides the above mentioned functions by the processor executing computer programs loaded in the memory.

### Processing Flow

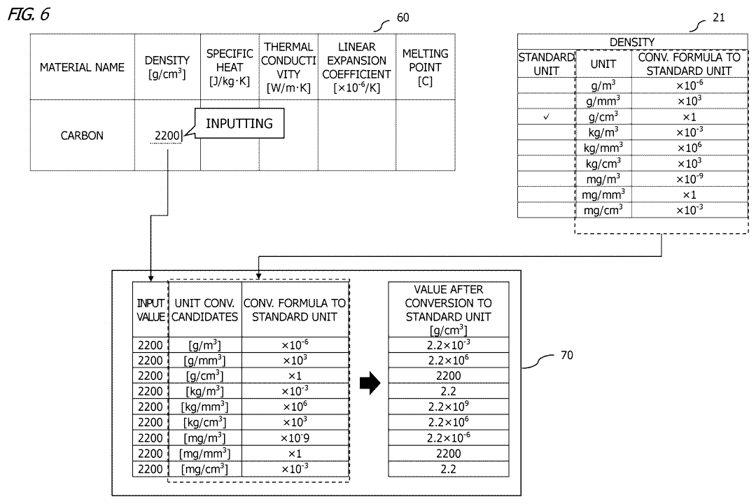

The method for processing numeric values inputted in this embodiment will be specifically described in accordance with steps S1 to S11 in a flow chart in FIG. 5.

In step S1, the user inputs a label (material name) to the input portion 30 via the input device 2, selects an attribute, and inputs a value of that attribute.

In step S2, the arithmetic portion 40 reads the attribute and the input value which were inputted to the input portion 30 in step S1. In the case of the example in FIG. 4, the attribute “density”and the input value “2200”are read.

In step S3, the arithmetic portion 40 acquires statistic information of existing data, which has the same attribute as the attribute which was read from the input portion 30, from the main database 10. For example, the arithmetic portion 40 acquires the value of the attribute “density” in the record which has been inputted to the main database 10.

In step S4, the arithmetic portion 40 acquires unit information, corresponding to the attribute which was read in step S2, from the unit database 20. For example, as indicated in FIG. 3, unit candidates of the attribute “density”, the standard unit among the unit candidates, and conversion formula used to convert each unit candidate into the standard unit, are acquired.

In step S5, the arithmetic portion 40 applies the conversion formula used to convert each unit candidate into the standard unit, acquired in step S4, to the input value, so as to calculate a value after each unit candidate is converted into the standard unit.

The sequence of the processing in step S3 and the processing in steps S4 and S5 may be reversed, or these processing steps may be executed in parallel.

In step S6, the arithmetic portion 40 calculates a score to be an index to determine the appropriateness of each unit conversion, based on the statistic information of existing data acquired in step S3, and the value after being converted into the standard unit calculated in step S5. An example of the calculation formula of this score follows.

S=|log₁₀x−log₁₀μ| (1)

Here S is a score, x is a value after being converted into the standard unit, and μis an average value of the existing data. The score calculated using Math (1) becomes closer to 0 as the value after being converted into the standard unit becomes closer to the average value of the existing data meaning it is evaluated as more appropriate.

Evaluation is performed by determining a logarithm of which base is 10, hence this method is suitable for a case of physical quantity where the unit candidates change by 10 times. The calculation formula of the score is not limited to the above mentioned calculation formula.

A method for calculating a value after the unit candidate is converted into the standard unit in this example, which correspond to the steps S4 to S6, will be specifically described, using an example of the case of registering the data of density of the material name “carbon”in the main database 10.

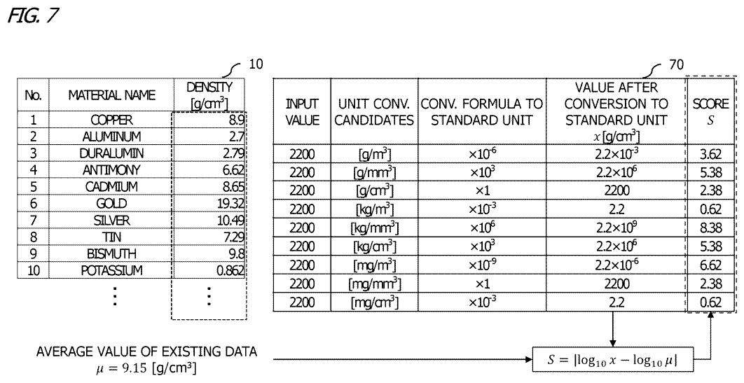

As indicated in FIG. 6, if “2200” is inputted as an input value of density, the arithmetic portion 40 acquires the input value “2200”, and records this value in the storage portion 70. The arithmetic portion 40 also reads the standard unit of density, unit candidates, and conversion formula used to convert each unit candidate into the standard unit, from the unit data 21 of density existing in the unit database 20, and records this information in the storage portion 70. Then the arithmetic portion 40 calculates a value after each unit candidate is converted into the standard unit, by applying the conversion formula used to convert each unit candidate into the standard unit to the input value “2200”, and records each calculated value in the storage portion 70. For example, the conversion formula to convert the unit candidate [g/m³] into the standard unit [g/cm³] is “×10⁻⁶”, hence the value after converting the input value “2200” from the unit candidate [g/m³] into the standard unit becomes 2.2×10⁻³ [g/cm³].

In this example, the method for calculating the score of each unit candidate using Math (1) will be described with reference to FIG. 7. First referring to the main database 10, the arithmetic portion 40 acquires an average value of the existing data which is required to calculate the score. Then based on the average value of existing data and the value after being converted into the standard unit which is recorded in the storage portion 70, the arithmetic portion 40 calculates the score of each unit candidate using Math (1), and records the result in the storage portion 70. In this example, the average density value of existing data is 9.15 [g/cm³], hence the score of the unit candidate [g/m³], for example, is calculated as follows.

S=|log₁₀(2.2×10⁻³)−log₁₀(9.5)|=|−2.66−0.96|=3.62

In the same manner, the score of the unit candidate [kg/m³] is calculated as follows.

S=|log₁₀(2.2)−log₁₀(9.15)|=|0.32−0.96|=0.64

In these two unit candidates, it is determined that the unit candidate [kg/m³], of which score is closer to 0, is statistically more appropriate than [g/m³].

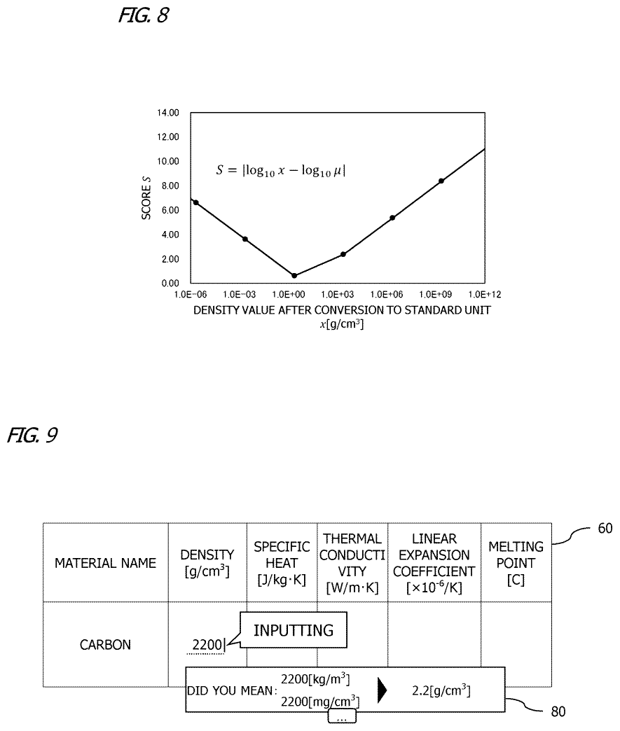

FIG. 8 indicates the relationship between the value after each unit candidate is converted into the standard unit and the score in this example.

In step S7, the arithmetic portion 40 determines whether the input value and a value after each unit converted into the standard unit are outliers. Determining whether or not a value is an outlier can be regarded as determining or evaluating whether or not the input value is appropriate. To determine whether the value is an outlier, in this embodiment, when the score calculated by Math (1) exceeds “2”, the value is determined as an outlier, for example. Here the score calculated by Math (1) exceeding “2” means that the value after being converted into the standard unit is different from the average value of the existing data by two digits or more. The threshold need not be set to “2” all the time, but may be set in accordance with the requirement, or may be set to a different value depending on the attribute.

Determination of an outlier is not limited to the above method of using the score, and may use the statistic information, such as the average, standard deviation, maximum value or minimum value, of existing data. Further, the probability distribution of the existing data may be estimated, so that the outlier may be determined using the value after being converted into the standard unit, and the likelihood of the converted value determined based on the estimated probability distribution.

In step S8, the display portion 50 displays each unit candidate by a different display method in according with the score calculated in step S6. For example, the display portion 50 displays one or a plurality of unit candidates having a highest score preferentially, or in a more prominent manner compared with other unit candidates. The display in step S8 is performed if the current input value is determined as an outlier, but may also be performed even if the current input value is not determined as an outlier when it is determined that unit candidates other than the standard unit are not outliers.

An example of the display method in step S8 will be described with reference to FIGS. 9 to 11. In this example, a first display is performed, where a part of a plurality of unit candidates, which are evaluated as appropriate, is displayed. For example, in the first display, a unit candidate having the highest score is displayed. If the user performs a predetermined operation in the state of the first display, a second display is performed, where all of the plurality of unit candidates, which are evaluated as appropriate, are displayed.

FIG. 9 is a diagram for describing the first display. FIG. 9 is an example of a display method where the first display 80 of the unit candidates is displayed on the input interface 60. Here the unit candidate is displayed as information which includes a numeric value after the input value in this unit is converted into the standard unit, and the score. In the example in FIG. 9, the scores of two unit candidates [kg/m³] and [mg/cm³] are the highest, and “2200 [kg/m³]” and “2200 [mg/cm³]”, which are values combining the input value and each unit candidate, are displayed, and “2.2 [g/cm³]”, which is a value after these values are converted into the standard unit, is displayed on the first display 80. On the first display 80, unit candidates other than the unit candidate having the highest score may be displayed, and, for example, all the unit candidates, of which values after being converted are not outlier, may be displayed.

In a state where unit candidates are displayed on the first display 80, if an input operation to select one of the unit candidates is performed, the input value is replaced with a value after the unit candidate is converted into the standard unit. In the example in FIG. 9, if the user selects [g/cm³], which is a unit candidate that is currently displayed, the value of the attribute “density” on the input interface 60 is replaced with “2.2”. In this way, conversion into a unit candidate that is likely to be the most appropriate can be easily performed.

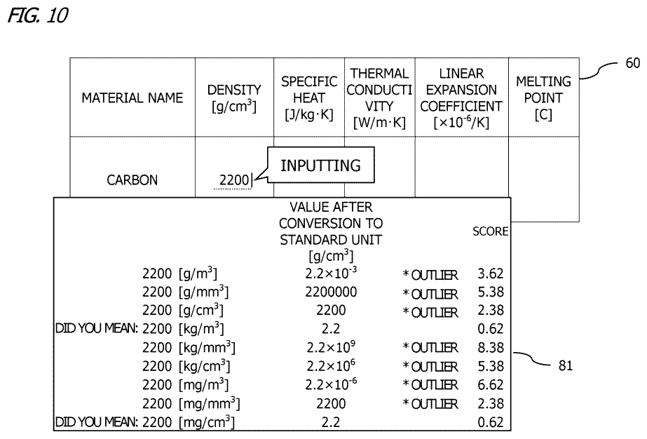

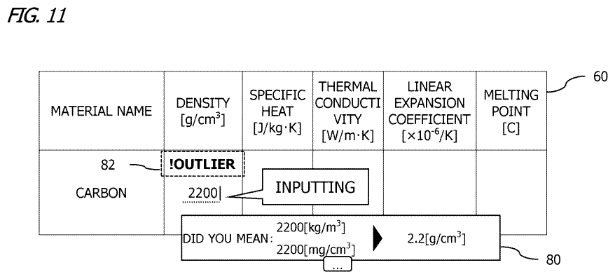

If the user performs a predetermined operation in the state of the first display 80, the display changes to a second display 81. FIG. 10 is an example of a display method where the second display 81 of the unit candidates are displayed on the input interface 60. On the second display 81, a value after being converted into the standard unit, a score, and a warning indicating that this is an outlier, are displayed for all the unit candidates of this physical quantity stored in the unit database 20. Although all the unit candidates are displayed here, only the unit candidates evaluated as appropriate may be displayed, without displaying the unit candidates evaluated as inappropriate. Just like the first display 80, the user can select a unit candidate out of the unit candidates that are displayed on the second display 81. When the unit candidate is selected, the input value on the input interface 60 is replaced with the value after the selected unit candidate is converted into the standard unit.

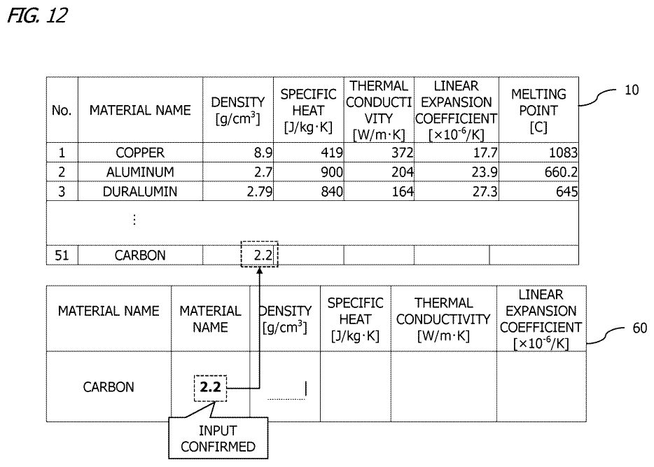

In a case where the inputted value is determined as an outlier in step S7, a warning is displayed on the input interface 60. FIG. 11 is an example of a display method to display a warning 82 on the input interface 60 in a case where the input value is determined as an outlier. When the user selects a unit candidate displayed in step S8, the current input value is replaced with the value after this unit candidate is converted into the standard unit.

In step S9, it is determined whether the user performed a determination operation to determine the input value. Processing advances to step S10 if the input value was changed without performing the determination operation. In step S10, the input portion 30 receives the change of input information. Then processing advances to step S2, and the processing steps from step S2 are performed for the changed input value. Processing advances to step S11 if the determination operation to determine the input value was performed in step S9.

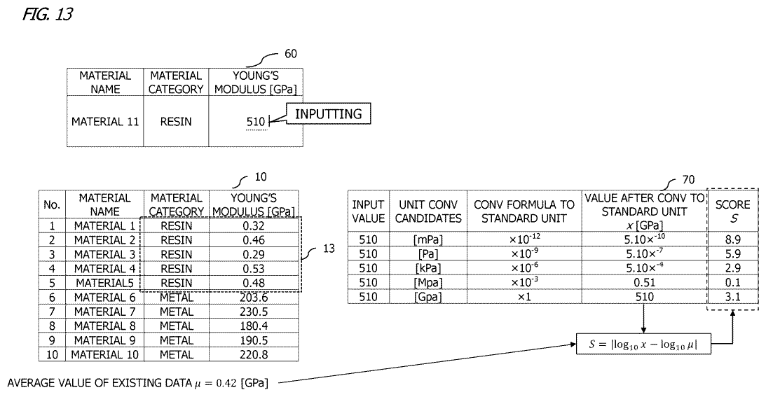

In step S11, the input portion 30 registers the input value of which input was determined in the corresponding attribute of the corresponding record of the main database 10, and the series of the processing flow ends. FIG. 12 is an example of the display of value i, of which input was determined, on the input interface 60, and the processing of registering the input value to the main database 10.

A number of unit candidates and the threshold of the score displayed on the first display 80 can be set by the user, and the first display 80 and the second display 81 may be the same. A different font and highlighting may be used depending on the score.

The data stored in the main database 10 and the unit database 20 may be displayed simultaneously with the input interface 60.

In the example of the above processing flow, values are inputted one-by-one, but even in a case where matrix type data is inputted all at once by copying and pasting, the above mentioned unit conversion processing can be performed for each value.

The values of the data already registered in the main database 10 can also be corrected in the same manner. In other words, when the data stored in the main database 10 is displayed, the above mentioned unit conversion processing can be performed.

In the present embodiment, each functional portion included in the information processing system may be installed in a plurality of different devices. For example, the main database 10 and the unit database 20 may be installed in a computer different from a computer in which the input portion 30, the arithmetic portion 40 and the display portion 50 are installed. In this example, the arithmetic portion 40 is a functional portion that mediates data exchange between the user and the main database 10, and performs the above mentioned processing based on the data acquired from the main database 10 and the unit database 20, and the data inputted to the input portion 30.

### SECOND EMBODIMENT

A second embodiment will be described next. An element denoted by a reference sign the same as the first embodiment has substantially the same configuration and function as the one described in the first embodiment, and differences from the first embodiment will be mainly described unless redundant description is necessary. In the second embodiment, the portion of determining a range of data to calculate the score will be described.

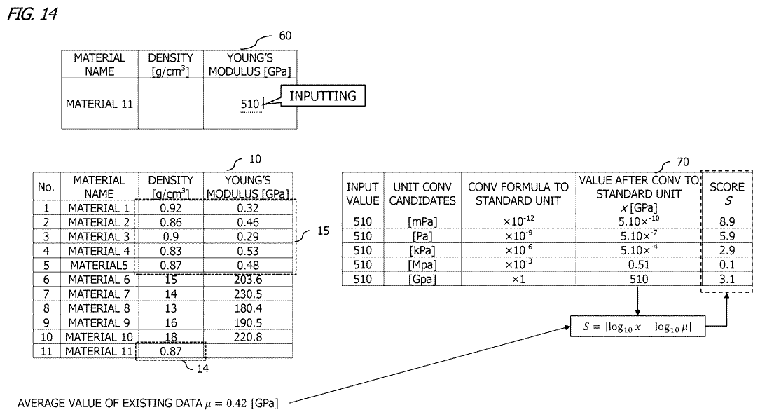

FIG. 13 is a diagram for describing an example of a method for calculating the score of the unit candidate according to the second embodiment. FIG. 13 indicates a state where the value “resin” is inputted to the attribute “material category”, and the value “510” is inputted to the attribute “Young's modulus”, in the input interface 60 provided by the input portion 30. Here “Young's modulus” is a first attribute to which a unit is set, and “material category” is a second attribute which is different from the first attribute. “Material category” can be interpreted as a second attribute that is different from a target attribute for calculating a score, which is an index of appropriateness of a unit candidate. The input information to be inputted to the input interface 60 includes numeric data, which is the attribute value “510” of “Young's modulus”, and category data, which is the attribute value “resin”of “material category”.

The main database 10 is in a state where already registered data exists, the value “resin” and the value “metal” are registered in “material category”, and “resin” and “metal” are registered with the values in “Young's modulus” in different digits. The arithmetic portion 40 calculates the average value of “Young's modulus” with reference to these data registered in the main database 10. Here the arithmetic portion 40 calculates the average value of “Young's modulus” only within a range 13, where the attribute “resin” of “material category” of the input interface 60 and the attribute “resin” of “material category” of the main database 10 match. Then the arithmetic portion 40 calculates the scores using this average value and the values after being converted into the standard unit which are stored in the storage portion 70. Thereby scores can be accurately calculated even if the numeric values of data in the main database 10, used for calculating the average value, are completely different from other data by digits.

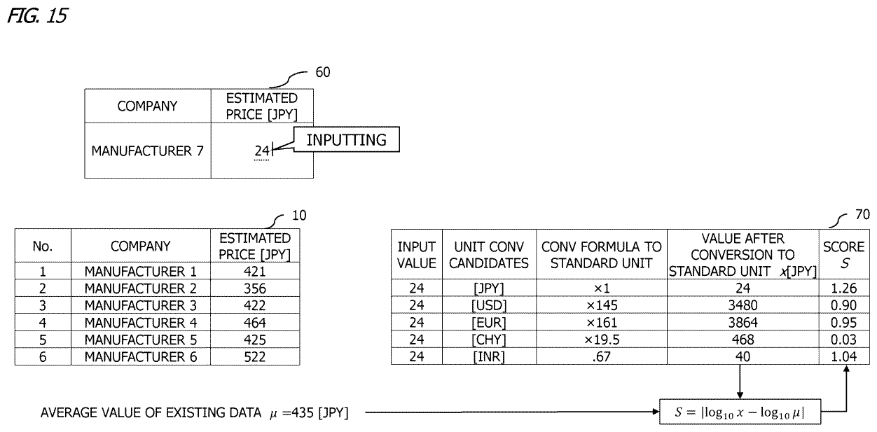

FIG. 14 is a diagram of an example of a method for calculating the score of the unit candidate according to a case different from FIG. 13. FIG. 14 indicates a state where the arithmetic portion 40 has already registered the attribute “density” of the value “material 11”, which is part of the attribute “material name”, to the value “0.87”, as indicated by the range 14, in the registered data of the main database 10. In this state, if the value “510” of “Young's modulus” is inputted to the input interface 60, the arithmetic portion 40 calculates the average value of “Young's modulus” only in the values of “density” in the range 15, which is ±50% (predetermined range) of the value “0.87” in the range 14 which has already been registered. The range is not limited to ±50%, and may be any range. The arithmetic portion 40 calculates the score using this average value and the value after being converted into the standard unit stored in the storage portion 70. Thereby scores can be accurately calculated even if the numeric values of data in the main database 10, used for calculating the average value, are completely different from other data by digits.

As described above, in the second embodiment, the existing data used for calculating the average value is limited to using attribute values of the specified second attribute based on the input information. Even if a plurality of types of data groups, of which attribute values are completely different by digits, are included in the existing data of the main database 10, the average value can be determined using similar types of data groups based on the second attribute, hence the score can be accurately calculated. Then based on the calculated score, the originally intended unit can be more appropriately estimated and presented to the user, which makes data input easier. In the above description, if the attribute value of the second attribute is included in the input information (example in FIG. 13), “the specified attribute value of the second attribute based on the input information” can be determined from the input information. If the attribute value of the third attribute is included in the input information, and the attribute value of the second attribute and the third attribute are included in the existing data (example in FIG. 14), the attribute value of the second attribute can be acquired using the third attribute as a key. The existing data used for the calculation of the average value may be limited to data including the specified second attribute based on the input information, or may be limited to data including the second attribute in a predetermined range, which includes this specified attribute value of the second attribute. Various embodiments described above may be combined to implement the invention.

### THIRD EMBODIMENT

A third embodiment will be described next. An element denoted by a reference sign the same as the above embodiments has substantially the same configuration and function as the one described in the above embodiments, and differences from the above embodiments will be mainly described, unless redundant description is necessary. In the third embodiment, a format of a database which handles items other than the material physical property values handled in the first embodiment will be described.

FIG. 15 is a diagram of an example of a database which manages the prices of products. In the main database 10, the attribute “company name” and the attribute “estimated price” have been registered. The main database 10 includes the input interface 60 provided by the input portion 30, and the value “24” of “estimated price” is currently being inputted. The arithmetic portion 40 calculates the average value of the estimated prices of the main database 10. Then using this average value and the values after being converted into the standard unit stored in the storage portion 70, the arithmetic portion 40 calculates the scores. In this example, currency is used as an example, but the present invention is not limited thereto. For example, the attributes for which score is calculated may be not only the material physical property value and currency, but also surface area, pressure, weight, length, load, energy, sound volume, time, capacity (bytes) and other attributes that are expressed by numeric values, and the present method is applicable to any of these attributes.

As described above, according to the present embodiment, the score can be accurately calculated even if items other than the material physical property values are handled. Based on the calculated score, the originally intended unit can be more appropriately estimated and presented to the user, which makes data input easier.

Various embodiments described above may be combined to implement the invention.

According to this disclosure, even if the inputted value is not appropriate, the originally intended unit can be more appropriately estimated and presented to the user, which makes data input easier.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-154142, filed on Sep. 6, 2024, and Japanese Patent Application No. 2025-123088, filed on Jul. 23, 2025 which are hereby incorporated by reference herein in their entirety.

What is claimed is:

1. An information processing system comprising:
an input portion configured to receive, as input to a main storage device that stores data including an attribute having a unit, input information comprising numeric data for the attribute;
an arithmetic portion, configured to evaluate, based on the input information and unit information, whether the numeric data included in the input information is appropriate when regarded as being expressed in each of a plurality of unit candidates, wherein the unit information includes information on the plurality of unit candidates that may be assigned to the attribute, information on a specified unit of the attribute that is selected from the plurality of unit candidates, and information on conversion from the plurality of unit candidates to the specified unit; and
a display portion configured to display, on a display device, a unit candidate, which differs from the specified unit, from among the plurality of unit candidates that are evaluated as appropriate.

2. The information processing system according to claim 1, wherein the arithmetic portion is further configured to calculate a score to be an index of appropriateness for each of the unit candidates, and to perform the evaluation based on the score.

3. The information processing system according to claim 2, wherein the display portion is further configured to display the unit candidates in different ways according to the score.

4. The information processing system according to claim 3, wherein the display portion is further configured to display one or a plurality of unit candidates having the highest score, more preferentially or more prominently than the other unit candidates.

5. The information processing system according to claim 1, wherein the display portion is configured to perform a first display to display a part of the plurality of unit candidates which are evaluated as appropriate, and to perform a second display to display all of the plurality of unit candidates which are evaluated as appropriate, in a case where a predetermined operation is performed in the state of the first display.

6. The information processing system according to claim 5, wherein in the second display, all of the unit candidates are displayed, including a plurality of unit candidates which are not evaluated as appropriate.

7. The information processing system according to claim 2, wherein the display portion is further configured to display each of the unit candidates on the display portion, along with a value, which is obtained by converting the numeric data from the unit candidate into the specified unit, and the score.

8. The information processing system according to claim 1,
wherein the input portion is configured to receive the input information through an input interface, and
wherein, in a case where a user selects any of the unit candidates being displayed, the display portion is configured to convert the numeric data currently being displayed on the input interface from the selected unit candidate into the specified unit, and to display the converted value.

9. The information processing system according to claim 1, wherein data stored in the main storage device comprises a record including a plurality of attributes.

10. The information processing system according to claim 1, wherein in a case where the numeric data regarded as being expressed in the specified unit is evaluated as inappropriate, the display portion is configured to display a unit candidate which is different from the specified unit. k 11. The information processing system according to claim 1, wherein in a case where the numeric data regarded as being expressed in the specified unit is evaluated as inappropriate, the display portion is configured to display a warning for the numeric data.

12. The information processing system according to claim 1, further comprising the main storage device and a unit storage device that stores the unit information.

13. The information processing system according to claim 1, wherein thel display portion is further configured to display data and the unit information stored in the main storage device, along with an input interface for inputting the input information and the unit candidate.

14. The information processing system according to claim 1,
wherein the display portion is configured to display data stored in the main storage device, and
wherein, in a case where data stored in the main storage portion regarded as being expressed in the specified unit is evaluated as inappropriate, the display portion is further configured to display a warning or a unit candidate evaluated as appropriate.

15. The information processing system according to claim 2,
wherein the data stored in the main storage device further includes a second attribute which is different from the attribute, and
wherein the arithmetic portion is further configured to calculate the score using data having the second attribute, which is specified based on the input information, from among the data stored in the main storage device.

16. The information processing system according to claim 2,
wherein the data stored in the main storage device further includes a second attribute which is different from the attribute, and
wherein the arithmetic portion is further configured to calculate the score using data having the second attribute, which is in a predetermined range and includes a value of the second attribute specified based on the input information, from among the data stored in the main storage device.

17. The information processing system according to claim 1, wherein the attribute is related to at least one of currency, surface area, pressure, weight, length, load, energy, sound volume, time and capacity (bytes).

18. An information processing method comprising:
an input step of receiving, as input to a main storage device that stores data including an attribute having a unit, input information comprising numeric data for the attribute;
an evaluation step of evaluating, based on the input information and unit information, whether the numeric data included in the input information is appropriate when regarded as being expressed in each of a plurality of unit candidates, wherein the unit information includes information on the plurality of unit candidates that may be assigned to the attribute, information on a specified unit of the attribute that is selected from the plurality of unit candidates, and information on conversion from the plurality of unit candidates to the specified unit; and
a display step of displaying, on a display device, a unit candidate, which differs from the specified unit, from among the plurality of unit candidates that are evaluated as appropriate.

19. A computer readable storage medium, non-transitorily storing a program causing a computer to execute:
an input step of receiving, as input to a main storage device that stores data including an attribute having a unit, input information comprising numeric data for the attribute;
an evaluation step of evaluating, based on the input information and unit information, whether the numeric data included in the input information is appropriate when regarded as being expressed in each of a plurality of unit candidates, wherein the unit information includes information on the plurality of unit candidates that may be assigned to the attribute, information on a specified unit of the attribute that is selected from the plurality of unit candidates, and information on conversion from the plurality of unit candidates to the specified unit; and
a display step of displaying, on a display device, a unit candidate, which differs from the specified unit, from among the plurality of unit candidates that are evaluated as appropriate.
